(19) United States
(12) Patent Application Publication
(10) Pub. No.: US 2025/0365285 A1
(43) Pub. Date: Nov. 27, 2025

(54) SYSTEMS AND METHODS FOR COMPUTER NETWORK SECURITY

(71) Applicant: Daniel Chien, Bellevue, WA (US)

(72) Inventor: Daniel Chien, Bellevue, WA (US)

(21) Appl. No.: 18/674,795

(22) Filed: May 24, 2024

(51) Int. Cl. H04L 9/40

(52) U.S. Cl. CPC H04L 63/101; H04L 63/20

(57) ABSTRACT

Techniques and systems for computer network security are described. One example system includes a computer security mechanism based on multiple security states that each allow successively increased levels of network access, where transitions between the security states occur in response to specified conditions or events. An example system starts (e.g., boots, initializes, powers up) in a first state in which no network communication is allowed. In response to an event such as a user starting a Web browser or other approved program, the system transitions into a second state, in which only outbound network communication is allowed. Thus, in the second state the Web browser can make an outbound request for information but any inbound connection requests will be rejected. In response to other events, the system transitions to security states that allow successively higher levels of network communication.

### TECHNICAL FIELD

The present disclosure relates to methods, techniques, and systems for computer network security, and more particularly to a computer security mechanism based on multiple security states that each allow successively increased levels of network access, where transitions between the security states occur in response to specified conditions or events.

### BACKGROUND

Hackers and other malicious parties are increasingly attempting to penetrate computing systems operated by home users, corporations, or governments. In many cases, these parties are attempting to steal information, damage equipment, install malicious software (e.g., viruses, Trojan horses, worms), or otherwise gain advantages over the network owner or operator. These attacks are frequently network-based. In some cases, the attacker attempts to gain remote access to a target network via security holes in publicly accessible computers (e.g., Web servers, mail servers). In other cases, the attacker attempts to gain local, physical access to the target network, such as by visiting a corporate site and connecting their computing device to the target network.

To address these security concerns, a variety of countermeasures exist. Hardware and software firewalls can be used to restrict certain types of network traffic. Firewalls can be configured, for example, to only allow inbound network traffic to specific ports, such as port 80 used by HTTP servers. Authentication, encryption, and privilege levels can also be used to limit access to certain programs and data that exists on a given computing system. While these and other countermeasures are effective in many circumstances, they are typically employed in a static, one-size-fits-all manner, such that they are unable to dynamically alter the level or scope of protection provided in response to the needs of users or the requirements of the underlying computing system.

### BRIEF DESCRIPTION OF THE DRAWINGS

FIG. 1 is a block diagram that illustrates a computer network security manager and associated components and systems according to example embodiments.

FIGS. 2A-2J are flow diagrams that illustrate network security processes according to example embodiments.

FIG. 3 is a block diagram of a computing system for implementing a network security manager according to an example embodiment.

### DETAILED DESCRIPTION

Embodiments described herein provide methods, devices, and systems for computer security, and more particularly a computer security mechanism based on multiple security states that each allow successively increased levels of network access, where transitions between the security states occur in response to specified conditions or events. In one example embodiment that uses the described techniques, a computing system starts (e.g., boots, initializes, powers up) in a first state in which the networking capabilities of the system are entirely or substantially disabled. For example, in the first state the system may only be able to initiate outbound network connections. Thus, a user of the system could use a Web browser to access network information as the browser typically only makes outbound HTTP requests and does not allow inbound connections. In response to certain events, conditions, and/or inputs, the computing system transitions to a second state that allows a further level of network access. For example, the second state may allow the computing system to accept inbound connections, but only if they are from a computing system on a local network, such as a managed network in a business, school, or home.

Various types of events may trigger the transition from one state to another. In the above example, the triggering event may be that the user started a specific program, such as a Web browser. The transition may also require the receipt of a user input, such as an indication that the user has granted permission to transition to the second, more capable network security state. The user may be an administrator, possibly operating a remote computing device, who grants permission for the computing system to start a program that requires a certain level of network capability, such as inbound SSH connections or the like. As another example, the triggering event occurs when a program executing on the computing system calls a networking library function (e.g., the “connect” or “accept” function/methods that are found in typical TCP socket implementations).

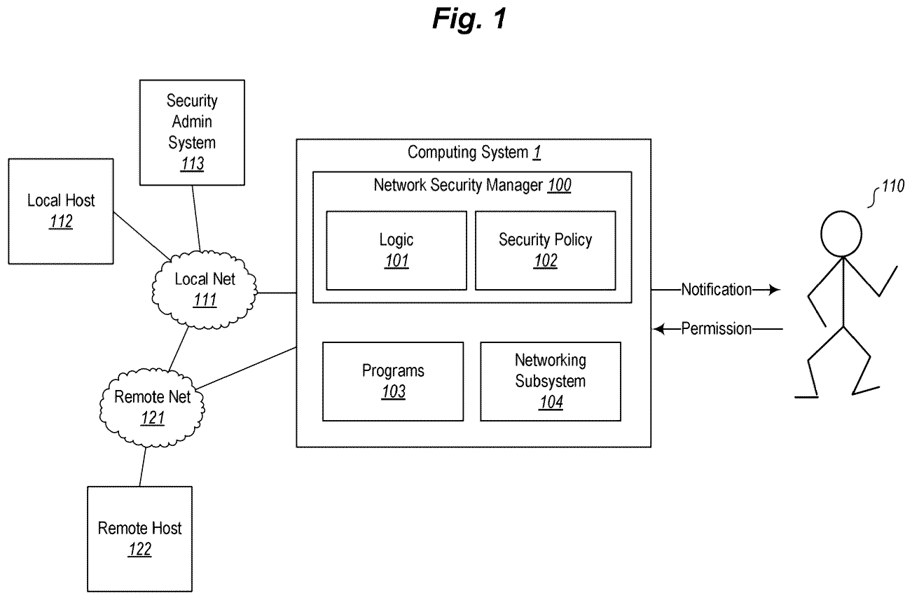

FIG. 1 is a block diagram that illustrates a computer network security manager and associated components and systems according to example embodiments. In FIG. 1, a network security manager 100 executes on a computing system 1. The computing system 1 also hosts one or more programs 103 and a networking subsystem 102. The programs 103 typically includes all of the programs available for execution on the computing system 1.

The computing system 1 is communicatively connected to a local network 111, which is communicatively connected to a local host 112, a security administration system 113, and a remote network 113. The computing system 1 may also be connected to the remote network 121 independently of the local network 111. For example, some computing systems may have multiple distinct logical of physical network interfaces. The remote network 113 is communicatively connected to a remote host 122. The computing system 1 is also configured to engage in interactive communication with a user 110.

The security manager 100 includes logic 101 and a security policy 102. The logic 101 implements one or more security mechanisms as described herein. The logic 101 implements one or more security states and controls the transitions between these security states according to one or more policies represented by the security policy 102. The security manager 100 can also restrict which programs of the one or more programs 103 that can be executed. This specifically includes any programs in 103 that can act as clients, servers, or otherwise engage in network communication.

A first example embodiment represents, provides, and manages five security states, each of which provide successively greater levels of network access. More specifically, the logic 101 represents the following five network states:
State 1: no network access is allowed. The computing system boots into State 1. In this state, any programs that attempt to call the networking subsystem 103 are stopped.
State 2: inbound traffic is not allowed; no open listening ports allowed.
   State 2a: outbound traffic to internal network (e.g., hosts connected to local network 111) is allowed.
   State 2b: outbound traffic to remote network (e.g., hosts connected to remote network 121) is allowed. Depending on the security policy 102, the logic 101 may check the remote IP address, for example by determining wither the address is in a white list of allowed IP addresses.
State 3: inbound network traffic is allowed for local hosts.
   State 3a: inbound network access for local users/hosts only is allowed. In this state, a connection from local host 112 to system 1 would be allowed but a connection from remote host 122 to system 1 would not be allowed. In this state, no SSH access is allowed. In other words, no user/host can access system 1 via the SSH protocol.
State 3b: local inbound SSH access is additionally allowed. In this state, local host 112 can initiate an SSH connection to system 1. In typical embodiments, system 1 allows SSH connections from approved local hosts, such as may be determined by a white list of approved local IP addresses.
State 4. remote inbound access is additionally allowed, without SSH access. For example, in this state remote host 122 is allowed to make an HTTP connection to system 1, but not an SSH connection. Again, a white list may be employed here to specify approved remote hosts.
State 5: remote inbound SSH access is additionally allowed. As above, a white list may be employed here to identify approved hosts. In this and other states, the system 1 may additionally require various forms of authentication, such as usernames, passwords, device identifiers, access tokens, or the like.

A second example embodiment represents, provides, and manages five security states, which are variations on those described above with respect to the first example embodiment. As above, each security state provides successively greater levels of network access. In this embodiment, the computing system 1 boots up in the first state, in which no network access is allowed. Network access is disallowed by interaction between the manager 100 and the networking subsystem 104. The networking subsystem is that that code (typically part of the operating system) which implements networking primitives, such as sending and receiving packets, establishing connections (e.g., TCP sockets), network address translation, and the like. The manager 100 has the rights to disable or otherwise limit certain networking functions implemented by the networking subsystem 104. In the first security state, the manager 100 disables all networking functions in the subsystem 104 and stops any of programs 103 that are trying to call the networking subsystem.

From the first security state, the computing system 1 then may transition to the second security state in which the system 1 allows outbound network connections and disallows inbound network connections. The transition occurs in response to a condition, event or input, such as a request to open a network connection made by one of the programs 103. For example, a Web browser may attempt to open a TCP connection (to transport an HTTP interaction) to a server executing on the local host 112 or the remote host 122. The manager 100 intercepts or is otherwise notified of the request and allows it, given that outbound connections are allowed in the second state. However, if the intercepted request is a request by a server program to open or allow the opening of an inbound connection (e.g., by calling the accept networking function), the networking action will be disallowed by the manager 100. A networking action can be disallowed by terminating the program that initiated the action or by not performing the action and returning an error code to the program instead.

From the second security state, the computing system 1 may transition to the third security state in which the system 1 additionally allows any server program to accept an inbound connection, so long as the connection is received from a local host, such as host 112. Again, this transition occurs in response to some condition, event, or input. For example, the manager 100 may detect an event, such as that a known server is starting (e.g., a secure shell server). The manager 100 may then also notify the user 110 that the server is starting and require permission (input) to proceed. Unless the permission is given, the server will not be allowed to start.

From the third security state, the computing system 1 may transition to the fourth security state in which the system 1 additionally allows inbound network connections from remote hosts, as long as those hosts are identified in a white list. In typical embodiments, inbound connections from remote hosts are allowed only so long as they are not SSH. In other embodiments, other protocols may be similarly limited or excluded, such as Telnet, RSH, or the like. Techniques for using a white list to evaluate a network communication using a white list are described in U.S. Pat. No. 10,084,791 (application Ser. No. 15/913,889), titled “Evaluating a Questionable Network Communication,” issued Sep. 25, 2018, the entire content of which is incorporated herein by reference.

From the fourth security state, the computing system 1 may transition to the fifth security state in which the system 1 additionally allows inbound network connections (including SSH) to and/or from any host so long as the connection is authenticated. Authentication may include checking one or more of a user identifier, password, security token, hardware identifier to determine whether the communication should be allowed. In addition, the computing system 1 may use timestamp-based authentication to authenticate connections, programs, and/or users. Timestamp-based authentication techniques are described in U.S. Pat. No. 10,826,912, (application Ser. No. 16/220,652), titled “Timestamp-Based Authentication” issued Nov. 3, 2020, the entire content of which is incorporated herein by reference.

In the above-described embodiments, each successive state allows the networking actions allowed in its predecessor states, such that a system in state N allows all of the actions allowed in states 1 . . . . N−1, in addition to any actions associated with state N. In other embodiments, the property need not apply, such that the set of actions allowed in state N is not necessarily a superset of the set of actions allowed in state N−1. In addition, other embodiments may utilized a greater or lesser number of security states. Also, various embodiments may employ different combinations of techniques described herein for detecting state transition event triggers, allowing/disallowing network access, and similar implementation related aspects.

Some embodiments may also combine techniques for suppressing denial-of-service (“DOS”) attacks or otherwise limiting the flow rate of inbound or outbound packets. For example, in the fourth security state described above (in which certain types of remote inbound network access are allowed) the system may drop network packets if they do not meet certain conditions, such as the use of authentic IP addresses and/or meeting specified pack flow rates. Techniques for suppressing DOS attacks are further described in U.S. Pat. No. 10,277,626 (application Ser. No. 15/808,283), titled “Systems and Methods for Suppressing Denial of Service Attacks,” issued Apr. 30, 2019, the entire content of which is incorporated herein by reference.

Some embodiments may also automatically transition from less restrictive security states to more restrictive security states. Such transitions may take place in response to certain inputs, events, or conditions. For example, the system may transition from security state in which certain types of inbound access are allowed to another security state in which no inbound access is allowed in response to the passage of a specified amount of network, user, or process idle time.

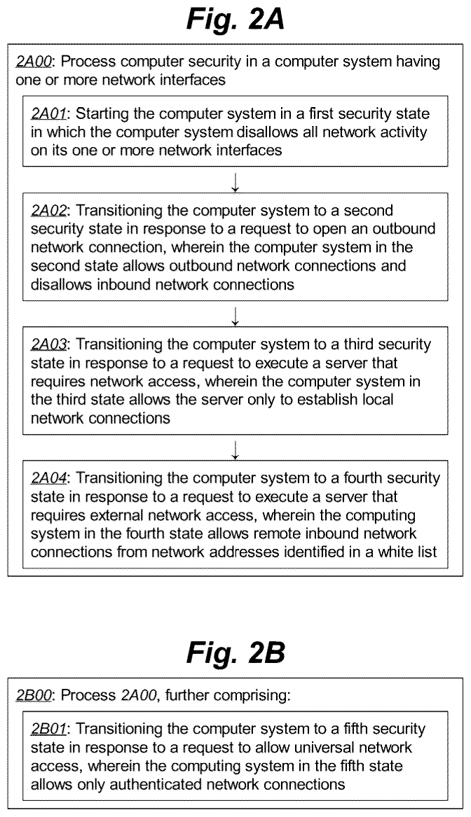

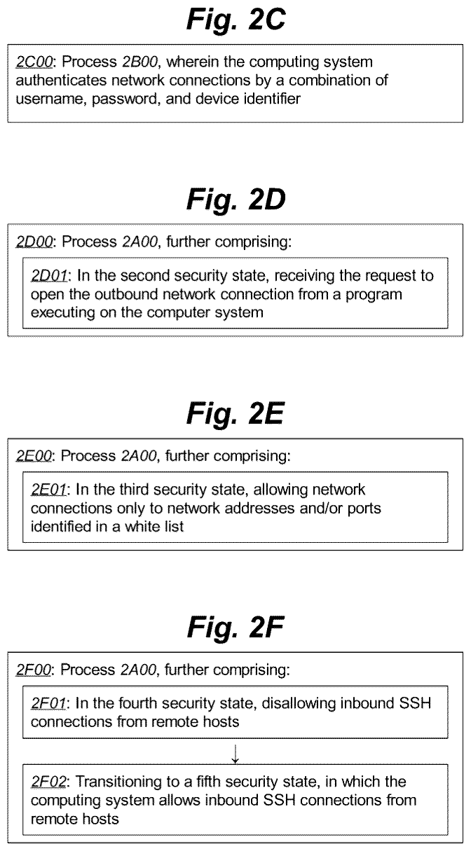

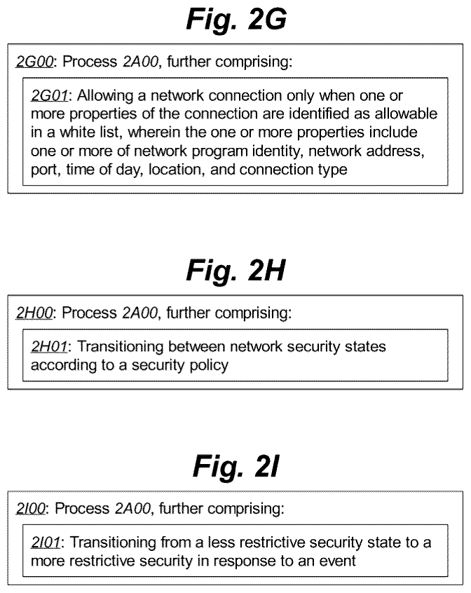

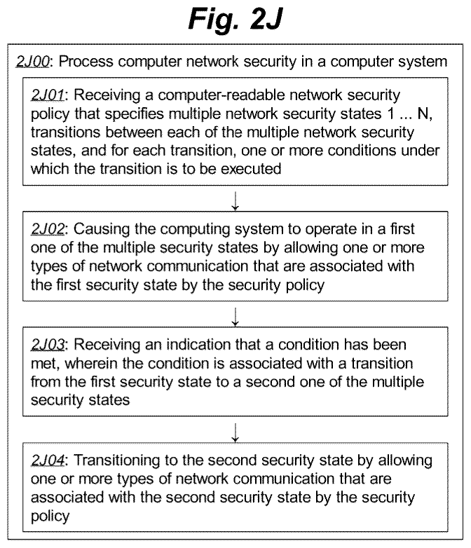

FIGS. 2A-2J are flow diagrams that illustrate network security processes according to example embodiments. The illustrated processes may be performed by the security manager 101 according to its logic 101 and security policy 102, as described with reference to FIG. 1, above.

FIG. 2A is a flow diagram of example logic for computer security in a computer system having one or more network interfaces. FIG. 2A illustrates a process 2A00 that includes block(s) 2A01-2A04 described below.

Block 2A01 includes starting the computer system in a first security state in which the computer system disallows all network activity on its one or more network interfaces. As noted, typical embodiments specify and implement multiple networking security states. These states are linked to one another and transitions occur in response to various events, inputs, pre-specified policies, or the like. Typically, the initial state is the most restrictive, with each further state becoming increasingly permissive. In the illustrated embodiment, the process starts (boots) in a first state which is substantially locked down, in that it disallows all network activity on its network interfaces, including sending or receiving any packets.

Block 2A02 includes transitioning the computer system to a second security state in response to a request to open an outbound network connection, wherein the computer system in the second state allows outbound network connections and disallows inbound network connections. The process next transitions to a second network security state in response to a request to open an outbound network connection. In the second state, the system disallows inbound network connections but allows outbound network connections. Disallowing an inbound network connection typically entails dropping certain types of network packets and/or restricting certain types of programs or code modules. For example, disallowing inbound connections may include dropping all inbound UDP packets, dropping TCP SYN packets (which are used to establish a TCP session), disallowing the creation of listening ports (by controlling the networking subsystem of the operating system), disallowing the execution of certain types of programs that are known to accept inbound connections, or the like. As noted above, some embodiments break this second state into two sub-states. In a first sub-state, the process allows only connections to hosts on an internal network, while in the second sub-state, the process additionally allows connections to remote hosts. Local/remote communication may be detected by reference to the IP address being used. Although the term ‘connection’ is used herein, this process and other embodiments may more generally allow or disallow network communication of various sorts, including unconnected communication, such as may be provided via the use of simple UDP packets.

Block 2A03 includes transitioning the computer system to a third security state in response to a request to execute a server that requires network access, wherein the computer system in the third state allows the server only to establish local network connections. The process next transitions to a third network security state in response to a request to execute a server or other program. In this state, the system allows local-only inbound network access. In other words, the server is only allowed to accept a connection from an IP address that is part of the local (physical or virtual) network to which the computing system is connected. This restricts the server to operating only with hosts that are part of a managed network, such as may be present in a school, business, or other entity. As noted above, some embodiments break this second state into two sub-states. In a first sub-state, the process does not allow SSH connections, while other types of connections (e.g., HTTP, FTP) are allowed. In the second sub-state, the process additionally allows inbound SSH connections, but only from approved hosts (e.g., as specified in a white list). As above, local/remote communication may be detected by reference to the IP address being used.

Block 2A04 includes transitioning the computer system to a fourth security state in response to a request to execute a server that requires external network access, wherein the computing system in the fourth state allows remote inbound network connections from network addresses identified in a white list. The process next transitions to a fourth network security state in response to a request for a server or service that can serve or otherwise accept connections from external hosts. In this state, a server can accept an inbound connection from a host on an external network, but can only do so if the IP address of that host is identified in a white list. The white list may be stored locally on the computing system in a protected mode, such that it cannot be modified by ordinary users. In other embodiments, the white list may be located on a remote, trusted computing system that can only be accessed via authenticated access protocol (e.g., requiring unique identifiers, passwords, and/or encrypted communication). In some embodiments, the process allows remote inbound connections so long as they are not SSH connections. In some embodiments, a fifth security state may also be provided, in which any authenticated inbound connection is allowed, including SSH connections.

FIG. 2B is a block diagram of example logic that extends the module 2A00 of FIG. 2A. More specifically, FIG. 2B illustrates a process 2B00 and which further includes the following block(s).

Block 2B01 includes transitioning the computer system to a fifth security state in response to a request to allow universal network access, wherein the computing system in the fifth state allows only authenticated network connections. In some embodiments, a fifth networking state is provided, in which the computing system is allowed to communicate with any network host provided that the communication with that host is authenticated. For example, the process may allow the execution of a server, so long as the server requires authenticated access, such as may be established via some combination of user identifier, device identifier, passwords, unique access tokens, or the like. Other requirements may also or instead be imposed, such as that the communication must be encrypted. In some embodiments, all connections must be authenticated via two-factor authentication.

FIG. 2C is a block diagram of example logic that extends the module 2B00 of FIG. 2B. More specifically, FIG. 2C illustrates a process 2000 which extends module 2B00 and wherein the computing system authenticates network connections by a combination of username, password, and device identifier. In one embodiment, authentication is performed by validating a combination of username (or other identifier of the user), password, and device identifier. The device identifier may be some hardware identifier of the remote system, such as MAC address, CPU identifier, unique disk identifier, or the like. In some cases, a device identifier is a combination of multiple hardware identifiers.

FIG. 2D is a block diagram of example logic that extends the module 2A00 of FIG. 2A. More specifically, FIG. 2D illustrates a process 2D00 and which further includes the following block(s).

Block 2D01 includes in the second security state, receiving the request to open the outbound network connection from a program executing on the computer system. The request may be programmatically generated such as when a program attempts to open a local port, connect to a remote port, or otherwise instantiate or create a networking component or object. In some embodiments, such function or method calls are intercepted by this process (or other security module of the operating system). In addition, the request may require user interaction. For example, when a call to connect to a remote system is made, the process may intercept or otherwise be notified of that call and in response prompt the user to give permission for the request to proceed. If the user withholds permission, the process can refuse to transition to the next security state. Permission may be obtained locally (e.g., via user interaction and/or reference to a file or other permission indicator) and/or by reference to an indication received from a remote computing system, such as a trusted computing system that controls the networking activities and security states of a collection of managed computing systems. Here, the process may employ other restrictive techniques, such as checking the remote IP address against a list of approved IP addresses. These described techniques to detect an attempted network connection event may be of course used with respect to other security states as well.

FIG. 2E is a block diagram of example logic that extends the module 2A00 of FIG. 2A. More specifically, FIG. 2E illustrates a process 2E00 and which further includes the following block(s).

Block 2E01 includes in the third security state, allowing network connections only to network addresses and/or ports identified in a white list. A white list may be employed in other security states in addition to or instead of the fourth state. In this variation/extension of the process, a white list is used in the third state to control which local hosts are allowable. In addition, as noted above, the third state may comprises two sub-states including a first sub-state in which SSH connections are not allowed and a second subsequent sub-state in which SSH connections are allowed.

FIG. 2F is a block diagram of example logic that extends the module 2A00 of FIG. 2A. More specifically, FIG. 2F illustrates a process 2F00 and which further includes the following block(s).

Block 2F01 includes in the fourth security state, disallowing inbound SSH connections from remote hosts. In some embodiments, remote SSH connections are disallowed from in the fourth security state because SSH allows malicious parties to execute a shell on the computing system and thereby execute programs, destroy data, and the like. In some embodiments, other remote access/execution services are also disallowed in the fourth state, such as RSH (remote shell), Telnet, and the like. In some embodiments, non-SSH remote execution services (e.g., Telnet) are permanently disabled as they are not as secure as SSH and do not provide any functionality beyond what is provided via SSH.

Block 2F02 includes transitioning to a fifth security state, in which the computing system allows inbound SSH connections from remote hosts. In the fifth state, the process allows even SSH and possibly other remote execution connections. As noted, typical embodiments permanently disable any non-SSH remote execution services on account of the security risks posed by such services.

FIG. 2G is a block diagram of example logic that extends the module 2A00 of FIG. 2A. More specifically, FIG. 2G illustrates a process 2G00 and which further includes the following block(s).

Block 2G01 includes allowing a network connection only when one or more properties of the connection are identified as allowable in a white list, wherein the one or more properties include one or more of network program identity, network address, port, time of day, location, and connection type. In any of the security states, the process may further restrict inbound or outbound network connections based on a white list. For example, in the present embodiment, in the fourth security state the process only allows connections from hosts that are identified in a white list. However, this white listing technique can be layered upon other security states, such as the third state above, such that only specified hosts on the local network can communicate with the computing system. In addition, the white list may specify one or more allowable network properties, such as time of day, location, address range, connection type (e.g., HTTP, FTP, SSH), and the like.

FIG. 2H is a block diagram of example logic that extends the module 2A00 of FIG. 2A. More specifically, FIG. 2H illustrates a process 2H00 and which further includes the following block(s).

Block 2H01 includes transitioning between network security states according to a security policy. In some embodiments, the process transitions between security states based on a security policy that may be formally specified via a standardized file format (e.g., XML) and/or executable instructions. In some embodiments, the security policy is contained in a read-only file that specifies the types of networking operations that are allowed or disallowed in each state, in addition to the conditions (e.g., events, inputs) under which the transitions from one state to another occur. The use of a security policy allows for customization of the various security states and mechanisms according to the needs of a specific user or organization. For example, a security policy may specify that the first security state disallows all networking and that the second network state allows only local networking. The policy may further specify that the transition from the first security state occurs whenever a request to open any type of network connection occurs, and further that the user is to be notified and prompted for permission to proceed to the second security state. As noted, permission may include on or more of interactively received permission from a human user, permission received from a security policy or other file or object on the local system, permission received from a remote trusted computing system, or the like.

FIG. 2I is a block diagram of example logic that extends the module 2A00 of FIG. 2A. More specifically, FIG. 2I illustrates a process 2I00 and which further includes the following block(s).

Block 2I01 includes transitioning from a less restrictive security state to a more restrictive security in response to an event. In some embodiments, the process is configured to automatically, in response to some event, condition, or input, transition from a less restrictive to a more restrictive security state. For example, the process may transition from the fourth to the third security state in response to the passage of a specified amount of network, process, or user idle time. By transitioning to more restrictive security states, the process causes the computing system to tend always to return to a more secure state of operation. Different transitioning conditions or events are contemplated, including the passage of time, time of day, login or logout of specified users or types of users, starting/stopping specified programs, network activity levels or flow rates, and the like.

FIG. 2J is a flow diagram of example logic for computer network security in a computer system. FIG. 2J illustrates a process 2J00 that includes block(s) 2J01-2J04 described below.

Block 2J01 includes receiving a computer-readable network security policy that specifies multiple network security states 1 . . . . N, transitions between each of the multiple network security states, and for each transition, one or more conditions under which the transition is to be executed, wherein each of the multiple network security states allows or disallows specified types of network access or communication, wherein security state 1 disallows all network communication and wherein each security state i allows a greater level of network communication than is allowed in state i−1. The policy may be represented as a computer-readable file, such as an XML file. The policy specifies security states and the types of network operations or communications that are allowed or disallowed in each state. In typical embodiments, the first state disallows all network communication and thus provides the highest level of security. The policy also specifies, for each state, a next state that provides additional level or type of network communication and the conditions under which a transition to the next state will occur. The transitions may occur automatically in response to the occurrence or meeting of a specified condition, such as the request to open, create, or accept a network connection; receipt of user permission; arrival of a specified time of day; reaching a specified network flow rate; or the like.

Block 2J02 includes causing the computing system to operate in a first one of the multiple security states by allowing one or more types of network communication that are associated with the first security state by the security policy. The process enforces a security state by automatically allowing or disallowing specified network actions or communications, such as the opening of a socket, receiving or sending a packet, or the like.

Block 2J03 includes receiving an indication that a condition has been met, wherein the condition is associated with a transition from the first security state to a second one of the multiple security states. The process may be informed by the operating system, which has been configured to notify the process when specified system calls are made, such as to open a socket, accept a connection, send/receive a packet, or the like. For example, when a process attempts to invoke the ‘accept’ system call, the process is notified by the operating system or some component thereof.

Block 2J04 includes transitioning to the second security state by allowing one or more types of network communication that are associated with the second security state by the security policy. Transitioning to a further state typically entails allowing one or more additional types of network communication, such as allowing inbound network communication from internal network hosts, allowing inbound network communication from hosts identified in a white list, allowing inbound SSH connections, or the like.

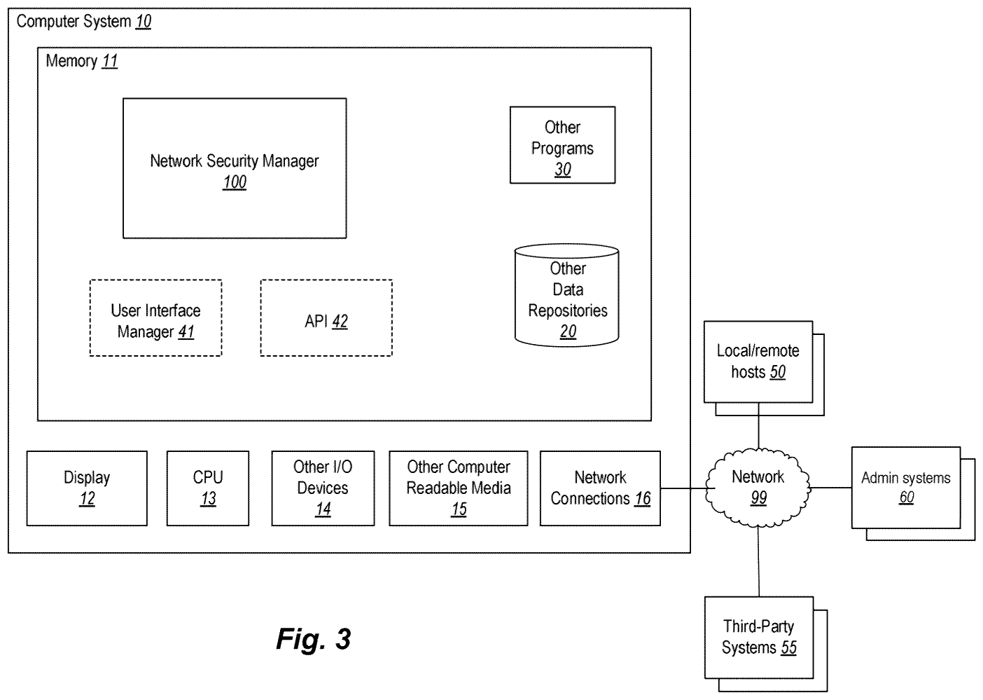

FIG. 3 is a block diagram of a computing system for implementing a network security manager according to an example embodiment. In particular, FIG. 3 shows a computing system 10 that executes the network security manager 100. The manager 100 implements the techniques described herein and with particular reference to FIGS. 1 and 2.

The computing system 10 may comprise one or more computing systems and may span distributed locations. In addition, each block shown may represent one or more such blocks as appropriate to a specific embodiment or may be combined with other blocks. Moreover, the various blocks may physically reside on one or more machines, which use standard remote procedure call (e.g., RPC) or proprietary inter-process communication mechanisms (IPC) to communicate with each other.

In the embodiment shown, computing system 10 comprises a computer memory (“memory”) 11, a display 12, one or more Central Processing Units (“CPU”) 13, Input/Output devices 14 (e.g., keyboard, mouse, CRT or LCD display, and the like), other computer-readable media 15, and a network connection 16. The security manager 100 is shown residing in memory 11. In other embodiments, some portion of the contents, some or all of the components of the security manager 100 may be stored on and/or transmitted over the other computer-readable media 15. Other modules may also be present in memory 11, such as the key generation processes 120, and/or a cryptography module 100. The security manager 100 preferably executes on one or more CPUs 13 and performs the techniques described herein. Other code or programs 30 (e.g., an administrative interface, a Web server, and the like) and potentially other data repositories, such as data repository 20, also reside in the memory 11, and preferably execute on one or more CPUs 13. Of note, one or more of the components in FIG. 4 may not be present in any specific implementation. For example, some embodiments may not provide other computer readable media 15 or a display 12.

The security manager 100 is shown executing in the memory 11 of the device 10. Also included in the memory 11 are a user interface manager 41 and an application program interface (“API”) 42. The user interface manager 41 and the API 42 are drawn in dashed lines to indicate that in other embodiments, functions performed by one or more of these components may be performed externally to the security manager 100.

The UI manager 41 provides a view and a controller that facilitate user interaction with the security manager 100 and its various components. For example, the UI manager 41 may provide interactive access to the security manager 100, such that users or administrators can interact with the security manager 100 such as to configure security policies, white lists, or otherwise control the behavior of the security manager 100. In some embodiments, access to the functionality of the UI manager 41 may be provided via a Web server, possibly executing as one of the other programs 30. In such embodiments, a user operating a Web browser executing on a client system or device can interact with the module 100 via the UI manager 41.

The API 42 provides programmatic access to one or more functions of the security manager 100. For example, the API 42 may provide a programmatic interface to one or more functions of the security manager 100 that may be invoked by one of the other programs 30 or some other module. In this manner, the API 42 facilitates the development of third-party software, such as user interfaces, plug-ins, adapters (e.g., for integrating functions of the module 100 into Web applications), and the like.

The security manager 100 may interact using network connection 16 via a network 99 with other devices/systems including computing systems 50, 55, and 60. The network 99 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices.

Computing systems 50, 55, and 60 may be constituted similarly to system 10. The security manager 100 may restrict communication with local/remote hosts 50 as described herein. Also, the administration system 60 may be used to configure the operation of the security manager 100. The system 60 may administer the operation of multiple security managers operating on a collection of computing systems operated by an organization, such as a school, business, government department, or the like. Also, the system 60 may grant or deny permission for the system 10 to move from one security state to another. In some cases, such permission may be granted programmatically, such as according to an administrative security policy stored on the system 60. In other cases, such permission may be granted (or not) based on interactive user input by an administrative user operating system 60.

Note that one or more general purpose or special purpose computing systems/devices may be used to implement and/or execute the security manager 100. However, just because it is possible to implement the security manager 100 on a general purpose computing system does not mean that the techniques themselves or the operations (taken alone or in combination) required to implement the techniques are conventional or well known. The techniques are not conventional at least because they address and improve an existing technology, such as by improving the operation, integration, or efficiency of one or more computing systems.

In an example embodiment, components/modules of the security manager 100 are implemented using software programming techniques. For example, the security manager 100 may be implemented as a “native” executable running on the CPU 13, along with one or more static or dynamic libraries. In other embodiments, the security manager 100 may be implemented as instructions processed by a virtual machine that executes as one of the other programs 30.

The various components may be implemented using more monolithic programming techniques, for example, as an executable running on a single CPU computer system, or alternatively decomposed using a variety of structuring techniques, including but not limited to, multiprogramming, multithreading, client-server, or peer-to-peer, running on one or more computer systems each having one or more CPUs. Some embodiments may execute concurrently and asynchronously, and communicate using message passing, remote procedure call, or other distributed computing paradigms. Equivalent synchronous embodiments are also supported. Also, other functions could be implemented and/or performed by each component/module, and in different orders, and by different components/modules, yet still achieve the described functions.

In addition, programming interfaces to the data stored as part of the security manager 100, such as in the data store 20, can be available by language-specific APIs; libraries for accessing files, databases, or other data repositories; through representational languages such as XML; or through Web servers, FTP servers, or other types of servers providing access to stored data. The data store 20 may be implemented as one or more database systems, file systems, or any other technique for storing such information, or any combination of the above, including implementations using distributed computing techniques.

Furthermore, in some embodiments, some or all of the components of the security manager 100 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

While embodiments of the invention have been illustrated and described, as noted above, many changes can be made without departing from the spirit and scope of the invention. Accordingly, the scope of the invention is not limited by the above disclosure.

1. A method for computer security in a computer system having one or more network interfaces, the method comprising:
starting the computer system in a first security state in which the computer system disallows all network activity on its one or more network interfaces;
transitioning the computer system to a second security state in response to a request to open an outbound network connection, wherein the computer system in the second state allows outbound network connections and disallows inbound network connections;
transitioning the computer system to a third security state in response to a request to execute a server that requires network access, wherein the computer system in the third state allows the server only to establish local network connections; and
transitioning the computer system to a fourth security state in response to a request to execute a server that requires external network access, wherein the computing system in the fourth state allows remote inbound network connections from network addresses identified in a white list.

2. The method of claim 1, further comprising:
transitioning the computer system to a fifth security state in response to a request to allow universal network access, wherein the computing system in the fifth state allows only authenticated network connections.

3. The method of claim 2, wherein the computing system authenticates network connections by a combination of username, password, and device identifier.

4. The method of claim 1, wherein the computer system disallows inbound network connections by refusing to open listening network ports, dropping all incoming TCP SYN packets, and/or refusing to execute remote login/shell/execution servers.

5. The method of claim 1, further comprising:
in the second security state, receiving the request to open the outbound network connection from a program executing on the computer system.

6. The method of claim 1, further comprising:
in the third security state, allowing network connections only to network addresses and/or ports identified in a white list.

7. The method of claim 6, further comprising: receiving the white list from a trusted network host.

8. The method of claim 1, further comprising:
in the fourth security state, disallowing inbound SSH connections from remote hosts; and
transitioning to a fifth security state, in which the computing system allows inbound SSH connections from remote hosts.

9. The method of claim 1, further comprising:
allowing a network connection only when one or more properties of the connection are identified as allowable in a white list, wherein the one or more properties include one or more of network program identity, network address, port, time of day, location, and connection type.

10. The method of claim 1, further comprising:
transitioning between network security states according to a security policy.

11. The method of claim 10, wherein the transitioning between network security states according to a security policy includes accessing a file that specifies one or more security states and, for each security state, a transition to one of the other security states, wherein each transition is associated with one or more conditions that cause the transition to occur.

12. The method of claim 10, wherein the transitioning between network security states according to a security policy includes accessing a file that specifies one or more security states and, for each security state, one or more networking operations that are allowed or disallowed.

13. The method of claim 10, wherein the transitioning between network security states according to a security policy includes
accessing a file that identifies the white list; and
restricting network communication according to the white list.

14. The method of claim 10, wherein the transitioning between network security states according to a security policy includes
accessing a file that identifies multiple security states, transitions between security states, and conditions under which the transitions occur, wherein each condition specifies an event which, when it occurs, causes a transition from one state to another; and
transitioning from a first one of the multiple security states to a second one of the multiple security states when one of the specified events occurs.

15. The method of claim 1, further comprising:
transitioning from a less restrictive security state to a more restrictive security in response to an event.

16. A method for computer network security in a computer system, the method comprising:
receiving a computer-readable network security policy that specifies multiple network security states 1 . . . N, transitions between each of the multiple network security states, and for each transition, one or more conditions under which the transition is to be executed, wherein each of the multiple network security states allows or disallows specified types of network access or communication, wherein security state 1 disallows all network communication and wherein each security state i allows a greater level of network communication than is allowed in state i−1;
causing the computing system to operate in a first one of the multiple security states by allowing one or more types of network communication that are associated with the first security state by the security policy;
receiving an indication that a condition has been met, wherein the condition is associated with a transition from the first security state to a second one of the multiple security states; and
transitioning to the second security state by allowing one or more types of network communication that are associated with the second security state by the security policy.

17. A computing system comprising:
a processor; and
a memory that stores instructions that are configured, when executed by the processor, to perform a process according to claim 1.

18. A computer-readable storage medium that stores instructions that are configured, when executed by a computing system, to perform a process according to claim 1.
